(19) United States
(12) Patent Application Publication
(10) Pub. No.: US 2009/0175598 A1
(43) Pub. Date: Jul. 9, 2009

(54) Move processor and method

(76) Inventors: Jian Chen, Irvine, CA (US); Dzanh C. Nguyen, Fountain Valley, CA (US)

Correspondence Address: HENNEMAN & ASSOCIATES, PLC, 714 W. MICHIGAN AVE., THREE RIVERS, MI, 49093, US

(21) Appl. No.: 12/008,208

(22) Filed: Jan. 9, 2008

(51) Int. Cl. H04N 7/26

(52) U.S. Cl. 386/124; 386/E05.001

(57) ABSTRACT

A method and apparatus for transferring protected digital AV content. The apparatus 10 includes a specially adapted microprocessor 12 with firmware allowing the microprocessor to control and transmit for storage and for display device 14 digital AV content data in the form of digital signals. A source storage device is connected to the microprocessor 12 by means of link 26. At least one sink storage device 20 is also connected to microprocessor 12 by link 28. The firmware allows the microprocessor to time the amount of material transferred to sink 20 to that allowed by the appropriate copy protection specification. The method limits the amount of data transferred to the programmed amount for example one second slices ending on a frame end. After each increment of data is transferred the amount remaining on source 16 is deleted. The process continues until all of the desired material is transferred from source 16 to sink 20.

### BACKGROUND OF THE INVENTION

1. Field of Invention

This invention relates generally to digital video and audio reproduction systems such as those used for home entertainment, and particularly to an apparatus and method for moving copy-protected content from one storage device to another.

2. Background Art

Video and audio entertainment content, comprising audiovisual (AV) objects such as movies, video programs, pictures, and music, is protected by copyright law and generally distributed with a limited use license. Formerly, some degree of security against copyright violation was afforded by the practical difficulty of making good copies, but now, content is produced and handled in the form of digital signals, which can be perfectly copied. Thus copy protection (also known as content protection), for example according to the Digital Transmission Content Protection (DTCP) specification known in the art, has become an important link in the distribution chain of commercial AV content to end users. In the current art, digital AV content is transmitted to the user over several different commercial distribution channels including cable, satellite, television (TV) and radio broadcast, short range wireless link, internet connection, and also delivered on prerecorded disks and other media. Many consumers want to store this content and move it between storage devices such as hard disk drives (HDDs), digital video disk (DVD) recorders (DVRs), flash drives, and the like, rather than use it when received, for greater convenience and accommodation of personal preferences about when to watch a movie or listen to music, and how to organize one's collection of AV objects, and on what type of media. For AV objects that have a copy protection status of “copy-no-more” according to the DTCP specification, the user can have only one (archival) copy of the object and another copy is not licensed to be made. However, conventional techniques of moving an AV object can create a temporary or even a permanent second copy of the object being moved, and in some systems, a nearly complete second copy can be obtained by powering down just before the end of a move. Thus there is a need for an apparatus and method to move digital AV content from one storage device to another that avoids making a copy, in compliance with the DTCP “copy-no-more” specification.

### SUMMARY OF INVENTION

The invention provides an apparatus and method to move protected AV content from one storage device (for example an HDD) to another storage device (for example another HDD), in compliance with DTCP “copy-no-more” specification, with a second copy limited to a one-second slice of the content bit stream at any time during the move, and with simple and convenient user control.

The apparatus includes a specially adapted microprocessor with firmware allowing the microprocessor to control, i.e., to store, read, erase (delete), and transmit for storage and for display and operatively in cooperation with conventional driver circuits and programs of instructions of the source storage device digital AV content data in the form of digital signals for example according to the known IEC 61883 and 1394TA AV/C standards, to and from other AV devices. The firmware allows the microprocessor to time the amount of material transferred to specification.

The method limits the amount of data transferred to the programmed amount, for example one second slices ending on a frame end. After each increment of data is transferred the amount remaining on the source is deleted. The process continues until all of the desired material is transferred.

### BRIEF DESCRIPTION OF THE FIGURES

FIG. 1 is a block diagram of an audiovisual system to which the present invention is applied;

FIG. 2 is a schematic diagram of the data structure of the digital AV content being moved, showing frames and segments of content in a portion of storage space on a source storage device, superposed with corresponding 1 sec time intervals;

FIG. 3 is a flow diagram of an embodiment of the method of moving protected content, according to the invention.

### DETAILED DESCRIPTION OF THE INVENTION

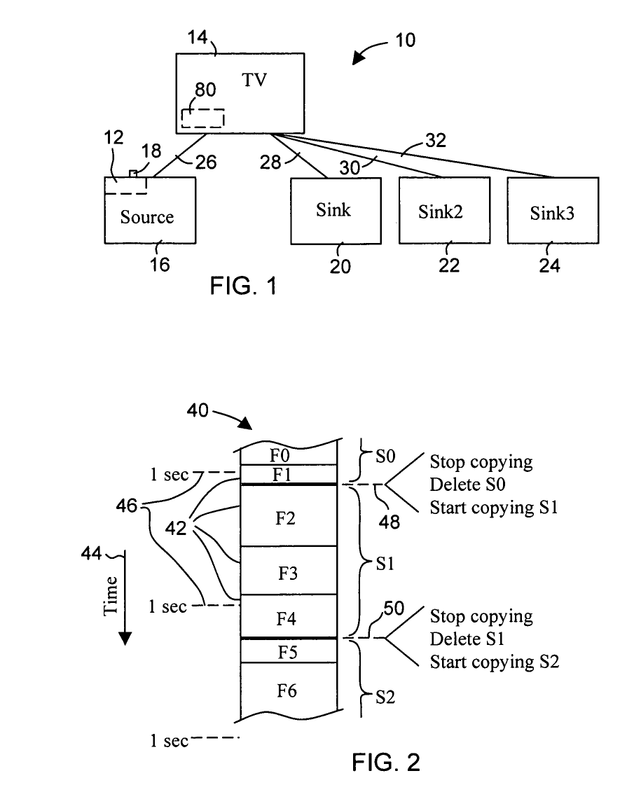

FIG. 1 is a block diagram of an audiovisual system to which the first embodiment of the present invention is directed. The audiovisual (AV) system 10 includes a move processor 12 for moving protected AV content according to the invention. The AV system 10 also includes a digital television (TV) device 14, a source storage device 16 (with included move processor 12), an attached user-accessible manual actuator 18, a plurality of sink storage devices 20, 22, 24, and interconnecting links 26, 28, 30, 32 over which control and AV content signals can be transmitted between the devices. Source storage device 16 may be a Hard Disk Drive (HDD) but also could be an equivalent. It will be apparent to those familiar with the art that other types of storage devices, other than HDDs, could alternatively be employed for this invention, for example flash drives, optical disk recorders such as DVRs and CDRs, card storage devices, and the like. Source storage device 16 is shown in FIG. 1 to be a separate device that is externally connected to TV 14, but it can alternatively be a subsystem component disposed inside the TV cabinet, with the manual actuator 18 remaining externally accessible to the user, for example on the control panel of TV 14. In this embodiment, the IEEE 1394 (herein referred to as “1394”) serial bus known in the art, which has been adopted as the High Definition Audio-Video Network Alliance (HANA) standard connection interface for AV device communication and control, can be used for the interconnecting links. Alternatively, other known interconnection means including for example Ethernet, Universal Serial Bus (USB), and 155 Mb/s ATM can be employed.

In the FIG. 1 embodiment move processor 12 comprises digital circuits and a firmware program of instructions stored in ROM which can be provided in the form of physical subsystem components, and alternatively in the form of a virtual subsystem with appropriate operational capability implemented in circuits and components having also other functionality, within source storage device 16, including also actuator 18, which are adapted to control, i.e., to store, read, erase (delete), and transmit for storage and for display and operatively in cooperation with conventional driver circuits and programs of instructions of the source storage device 16, digital AV content data in the form of digital signals for example according to the known IEC 61883 and 1394TA AV/C standards, to and from other AV devices. It is understood that appropriate control circuits in storage devices 16, 20, 22, 24 and TV 14 can interact with each other to implement links 26, 28, 30, 32 and the data transmission as required in moving AV content. The program of instructions can be implemented in a known computer language, for example C.

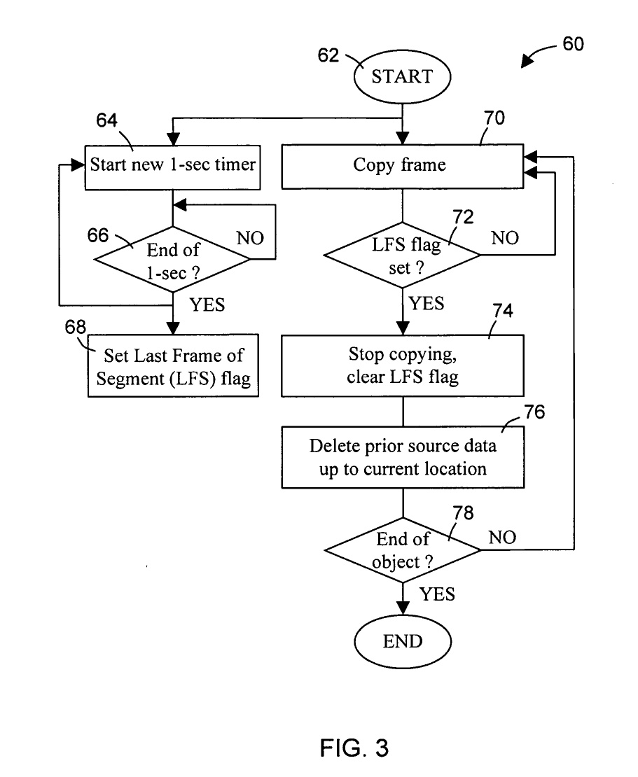

Operation of move processor 12 according to the method of the invention may be understood with reference to FIG. 2, showing the data structure of an example of digital AV content that can be stored and moved, and also with reference to FIG. 3 depicting a flow diagram of an embodiment of the move method. Digital AV content can be stored on a storage device, for example source device 16, as a sequence of frames 42 of an AV content object, such as a movie, with each frame comprising a sequence of data bits, and alternatively a stack of data words. Frames generally have different lengths in time depending on the details of the content, and the compression employed. FIG. 2 shows a portion 40 of data storage space on source storage device 16, comprising a sequence of frames F0, F1, F2, F3, F4, F5, and F6, which represent a portion of an exemplary AV object. AV content is moved, according to the invention, for example to a sink device 20, in consecutive approximately 1-second segments comprising a plurality of complete frames. It should be noted that the 1-second segment length is illustrative, and in alternate embodiments the segment can be shorter than 1 second, or longer than 1 second, as long as it is an insignificant portion of the AV object being moved, in terms of DTCP compliance. The example storage space portion 40 is shown in FIG. 2 to comprise three segments S0, S1, S2, and the time direction of the data is indicated by time arrow 44. Owing to the variable length of frames in time, the number of frames in a segment is not fixed. When the last complete frame of a segment is copied (read from source storage device 16 and transmitted) to sink device 20, that segment is deleted (erased) from source device 16, and copying of the next segment begins. A fixed 1-second timer implemented in the move processor 12, is used to identify the last full frame to be copied, by setting a last-frame-of-segment (LFS) flag at fixed 1-second time intervals, and thus also the next frame, which becomes the first frame of the next segment to be copied. The timer can be implemented in the form of a firmware program of instructions in move processor 12. The 1-second time points 46 generally fall within a frame, but copying, and deletion, starts at the beginning of a frame and stops at the end of another frame. Accordingly, for example, if frame F1 is being moved and a 1-sec time point falls in that frame (or at the end of that frame), the LFS flag will be set, and F1 will be identified as the last frame of segment S0 and F2 as the first frame of segment S1, as shown in FIG. 2. Thus at time point 48 at the end of frame F1, move processor 12 will stop copying the sequence of data bits, delete all prior stored content data of the AV object being moved, i.e., all frames of S0 up to the end of F1, clear the LSF flag, and start copying segment S1 at the beginning of frame F2. If the next 1-sec time point falls in frame F4, move processor 12 will operate in a like manner at time point 50 at the end of frame F4 to stop copying, delete prior stored content, i.e., frames F2, F3, and F4, and start copying segment S2 at the beginning of frame F5. It will be apparent that at the end of a complete move, all prior stored content on the source device will be deleted. Thus move processor 12 operates, according to the inventive method, to read content data from a source storage device and to transmit it and store it on a sink storage device, one 1-second segment at a time, and to delete previous segments of the source copy continually during the move. At the end of moving an AV content object, all prior stored content has been erased, and during a move there is no time at which a temporary second copy exists that represents more than 1 second of content length in time.

A flow diagram of the move method of the invention is depicted in FIG. 3, showing a sequence of steps 60 of an embodiment of the method. Performance of the method starts with a user command step 62 in which a digital AV content object on the source device HDD 16, and a target sink device to which the object will be moved, are identified, and which will be presently described in further detail hereinbelow. In the next step 64 a 1-second fixed interval timer is started, which continues in loop step 66 until the end of an interval, when a new 1-second interval is started by branching back to step 64 and also in the next step 68 the LFS flag described hereinabove is set. In parallel with the timer, and at the same time as step 64, copying of the content from source to sink starts in step 70, from the beginning of the first frame of the identified digital AV object, and continues serially in time until the end of the frame, when operation passes to the next step 72. In step 72 the LFS flag is checked at suitable time intervals shorter than 1 second, and if the flag is clear, operation loops back to step 70 and the next frame is copied (read and transmitted) serially in time. If in step 72 the LFS flag is found to be set, then operation branches to step 74, wherein copying stops, the LFS flag is cleared, and operation continues to step 76, wherein prior source data, i.e., stored content on source storage device 16 of the object being moved, is deleted (erased), up to the current location in the data storage space, which is the end of the last frame copied, and also the end of the last segment. If in the next step 78 it is found that there is a next frame, and the last frame was not the end frame of the object, then operation branches back to step 70 and the next frame, which is also the first frame of the next segment, is copied. If the end of the object is found in step 78, the move ends.

It will be apparent to those familiar with the art that a program of instructions to perform the described sequence of steps 60 can be implemented in ways that may differ in detail, while accomplishing the same results and objectives, without departing from the scope and spirit of the invention.

A convenient and user-friendly start command for a move can be provided in this embodiment by the manual actuator 18 shown in FIG. 1, which can be a push button switch operationally connected to move processor 12 and disposed on the storage device enclosure, and alternatively on the TV 14, for example on the control panel as noted hereinabove, and labeled as the “move” button. In a system environment with only one (default) sink storage device 20, the user command can be adapted to require no other control action than pushing the move button, and no interaction of the user with the TV 14. Such a single-button command will be simpler and easier to use than the conventional method of entering a user command from a remote control with the help of a menu displayed on the TV. Some of the convenience of a single-button move command can be retained also with a plurality of sink storage devices, shown in FIG. 1, by providing for selection of a target sink device from a list of sink storage devices 20, 22, 24 displayed on TV 14. For example, said list can be displayed in response to actuation of the move button by the user; and the selection can be implemented by means of multiple button pushes (manual actuations) that advance a pointer sequentially through the list; and further, the final choice can be registered by the last push that is actuated within a predetermined time limit between pushes. Alternatively, a manual selection wheel or lever can be provided for advancing the pointer; and the choice can be registered by an elapsed time, and alternatively, by a second actuation of the move button. Alternatively with a plurality of sink storage devices, the move processor 12 can be adapted to choose a predetermined default sink device, and yet alternatively, the first available sink device, from the 1394 bus interconnection links 28, 30, 32 according to conventional bus operation, upon user actuation of the move button.

In an alternate AV system embodiment, a move processor 80 disposed inside the TV 14 cabinet can be provided, without a manual actuator accessible to the user, as shown in dashed lines in FIG. 1. In this embodiment the associated source storage device, for example an HDD, can be also disposed inside the TV cabinet, or alternatively, a source storage device can be externally disposed, the distinguishing feature of the embodiment being the absence of a manual move actuator or move button. User control of the move can be in this case initiated (and a sink selected, if that is required) by means of the display and the control devices of the TV in the conventional manner, for example front panel controls of the TV or a remote control unit. It will be necessary in this embodiment for the control signals of the TV to interact suitably with the move processor 80, in order to initiate the move as described hereinabove, and for this purpose, vendor-unique commands can be provided in the TV command set, with appropriate corresponding modifications in the firmware of the move processor 80 so that it can in other respects operate in the same manner as move processor 12, as described hereinabove.

Various modifications may be made to the invention without altering its value or scope. For example, while this invention has been described herein using the example of the move processor 12, many or all of the inventive aspects are readily adaptable to other AV designs, other sorts of entertainment equipment, and the like.

It is expected that there will be a great many applications for these which have not yet been envisioned. Indeed, it is one of the advantages of the present invention that the inventive method and apparatus may be adapted to a great variety of uses.

All of the above are only some of the examples of available embodiments of the present invention. Those skilled in the art will readily observe that numerous other modifications and alterations may be made without departing from the spirit and scope of the invention. Accordingly, the disclosure herein is not intended as limiting and the appended claims are to be interpreted as encompassing the entire scope of the invention.

### INDUSTRIAL APPLICABILITY

The inventive apparatus and method are intended to be widely used in a great variety of electronic applications. It is expected that they will be particularly useful in consumer electronic applications where significant storage capacity and speed is required.

It is anticipated that the continually deleting (erasing) content move and the single-button push user command will have wide use in all types of media storage devices such as HDDs, flash memory card and stick recorders, DVDRs, TVs and other types of media players of audiovisual and musical content.

Since the inventive storage system and method of the present invention may be readily produced and integrated with existing tasks, input/output devices and the like, and since the advantages as described herein are provided, it is expected that they will be readily accepted in the industry. For these and other reasons, it is expected that the utility and industrial applicability of the invention will be both significant in scope and long-lasting in duration.

1. A method for transferring protected digital AV content from a source storage device to a target sink storage device comprising the steps of, identifying a digital AV content object on said source device and a target sink device to which the object will be moved, and copying the content from said source to said sink from the beginning of a portion of said identified digital AV object, and continuing serially in time until the end of said portion, and setting an indicator at the end of said interval, and deleting the portion which has been copied on said source storage device, and continuing the process until the end of the object is found at which time the move ends.

2. A method for transferring protected digital AV content from a source storage device to a target sink storage device as in claim 1, wherein said portion stops copying at the end of a frame.

3. A method for transferring protected digital AV content from a source storage device to a target sink storage device as in claim 1, further comprising the step of starting a fixed interval timer when said copying step starts.

4. A method for transferring protected digital AV content from a source storage device to a target sink storage device as in claim 3, wherein said interval is one second.

5. A method for transferring protected digital AV content from a source storage device to a target sink storage device as in claim 3, comprising the further step of setting an indicator at the end of said interval.

6. A method for transferring protected digital AV content from a source storage device to a target sink storage device as in claim 5, wherein said indicator is a last frame of segment flag and copying does not cease until the end of the last frame at which said timer interval occurs.

7. A method for transferring protected digital AV content from a source storage device to a target sink storage device as in claim 6, wherein said indicator is cleared prior to said deletion step.

8. A method for transferring protected digital AV content from a source storage device to a target sink storage device as in claim 1, wherein there are multiple sink devices.

9. A method for transferring protected digital AV content from a source storage device to a target sink storage device as in claim 1, wherein said protected AV content object is moved to said sink storage device in response to actuation of a manual actuator.

10. A device for transferring protected digital AV content comprising: a source storage device for initially storing protected digital AV content; and a move processor connected to said source storage device including firmware for transferring content from said source storage device in small increments and deleting the previous increment before transferring the next increment of stored protected digital AV content; and a sink storage device connected to said move processor for receiving transferred protected digital AV content.

11. A device for transferring protected digital AV content as in claim 10, wherein said source storage device is a hard disk drive.

12. A device for transferring protected digital AV content as in claim 10, wherein said sink storage device is a hard disk drive.

13. A device for transferring protected digital AV content as in claim 10, wherein there is a plurality of sink storage devices connected to said move processor.

14. A device for transferring protected digital AV content as in claim 10, further comprising a manual actuator connected to said move processor.

15. A device for transferring protected digital AV content as in claim 10, wherein the connection of said storage devices to said move processor is by means of an IEEE 1394 serial bus.

16. A device for transferring protected digital AV content as in claim 10, wherein the connection of said storage devices to said move processor is selected from the group of Ethernet, Universal Serial Bus (USB), and 155 Mb/s ATMs.

17. A device for transferring protected digital AV content as in claim 10, wherein said increment is a preselected time interval plus the time interval to the end of the next frame of said protected AV content.

18. A device for transferring protected digital AV content as in claim 17, wherein said preselected time interval is substantially one second.
